(19) United States
(12) Patent Application Publication
(10) Pub. No.: US 2003/0144006 A1
(43) Pub. Date: Jul. 31, 2003

(54) Methods, systems, and computer program products for determining the location of a mobile terminal based on delays in receiving data packets from transmitters having known locations

(76) Inventors: Mikael Johansson, Morrisville, NC (US); Elena Casanova, Raleigh, NC (US); Anders Gothe, Morrisville, NC (US)

Correspondence Address: MYERS BIGEL SIBLEY & SAJOVEC, PO BOX 37428, RALEIGH, NC, 27627, US

(21) Appl. No.: 10/056,261

(22) Filed: Jan. 25, 2002

(51) Int. Cl. H04Q 7/20

(52) U.S. Cl. 455/456; 455/457

(57) ABSTRACT

The location of a mobile terminal is determined by receiving, at the mobile terminal, data packets from at least three transmitters whose locations are known. The delays for the data packets to travel from the transmitters to the mobile terminal are determined and then the location of the mobile terminal is determined based on the delays and the locations and of the transmitters.

### BACKGROUND OF THE INVENTION

The present invention relates to wireless communication technology, and, more particularly, to methods, systems, and computer program products for determining the location of a mobile terminal.

Wireless communication technologies are widely used to provide communications services. For example, cellular mobile telephone systems are used throughout the world to provide telephone voice services. Wireless communications services are also widely used to provide text and other messaging services, such as paging services.

A growing market for the application of wireless communication technologies is the provision of data communication services. For example, wireless mobile data communication systems are now used to provide wireless wide area networking such that mobile users, such as salespeople, maintenance personnel, and the like, may use networked applications. Wireless mobile data communications system may also be used to provide mobile Internet services.

A conventional cellular digital packet data (CDPD) communication system 112 is illustrated in FIG. 1. The CDPD system 112 includes a CDPD subscriber device known as a mobile end station (M-ES) 114. The M-ES 114 and a mobile data base station (MDBS) 116 communicate with each other using a CDPD communication protocol. The MDBS 116 communicates with a mobile data intermediate system (MD-IS) 118, which provides such functionality as authenticating M-ESs to ensure that service is only provided to registered users, managing M-ESs as they move from cell to cell and/or change channels within a single cell, and accounting services. Commonly, the MDBSs 116 communicate with the MD-ISs 118 using a transport layer/network layer stack such as TCP/IP (transport control protocol over Internet protocol), UDP/IP (user datagram protocol over Internet protocol) or TP4/CNLP (transport protocol 4 over connectionless protocol). To provide access to other networks, the MD-IS 118 is connected to a router 122, which routes traffic to private networks 124, the Internet 126, and other CDPD service providers 128. A detailed discussion of CDPD may be found in “Cellular Digital Packet Data Networks,” by Budka et al., Bell Labs Technical Journal, Summer 1997, pp. 164-181. Other wireless mobile data communication systems include general packet radio system (GPRS), which provides packet data communications for global system for mobile communications (GSM) and other time-division multiple access (TDMA) systems, code division multiple access (CDMA) systems, and universal mobile telecommunications systems (UMTS).

Wireless mobile data communication systems commonly use existing wireless voice communications infrastructure. For example, CDPD services may be provided by retrofitting existing Advanced Mobile Phone System (AMPS) base stations with supplemental hardware that enables these base stations to serve as MDBSs in the CDPD network.

Subscribers of CDPD networks may desire to be able to determine their current location using their M-ESs. In conventional CDPD networks, MDBSs may provide M-ESs with the locations of the cells that they are registered in. Typical cell sizes, however, have a radius of up to 10 miles. Unfortunately, this level of precision may be unsatisfactory to some CDPD network subscribers.

### SUMMARY OF THE INVENTION

According to embodiments of the present invention, the location of a mobile terminal is determined by receiving, at the mobile terminal, data packets from at least three transmitters whose locations are known. The delays for the data packets to travel from the transmitters to the mobile terminal are determined and then the location of the mobile terminal is determined based on the delays and the locations of the transmitters.

### BRIEF DESCRIPTION OF THE DRAWINGS

Other features of the present invention will be more readily understood from the following detailed description of specific embodiments thereof when read in conjunction with the accompanying drawings, in which:

FIG. 1 is a network schematic that illustrates a conventional cellular digital packet data (CDPD) communication network;

FIG. 2 is a network schematic that illustrates a CDPD communication network in accordance with embodiments of the present invention

FIG. 3 is a block diagram that illustrates a mobile terminal in accordance with embodiments of the present invention;

FIG. 4 is a block diagram that illustrates a software architecture for use in mobile terminals in accordance with embodiments of the present invention;

FIG. 5 is a block diagram that illustrates a data processing system in accordance with embodiments of the present invention;

FIG. 6 is a block diagram that illustrates a software architecture for use in data processing systems in accordance with embodiments of the present invention;

FIGS. 7-10 are flowcharts that illustrate operations for determining the location of a mobile terminal based on delays in receiving data packets from transmitters having known locations in accordance with embodiments of the present invention; and

FIG. 11 is a network schematic that illustrates operations for determining the location of a mobile terminal based on delays in receiving data packets from transmitters having known locations in accordance with embodiments of the present invention.

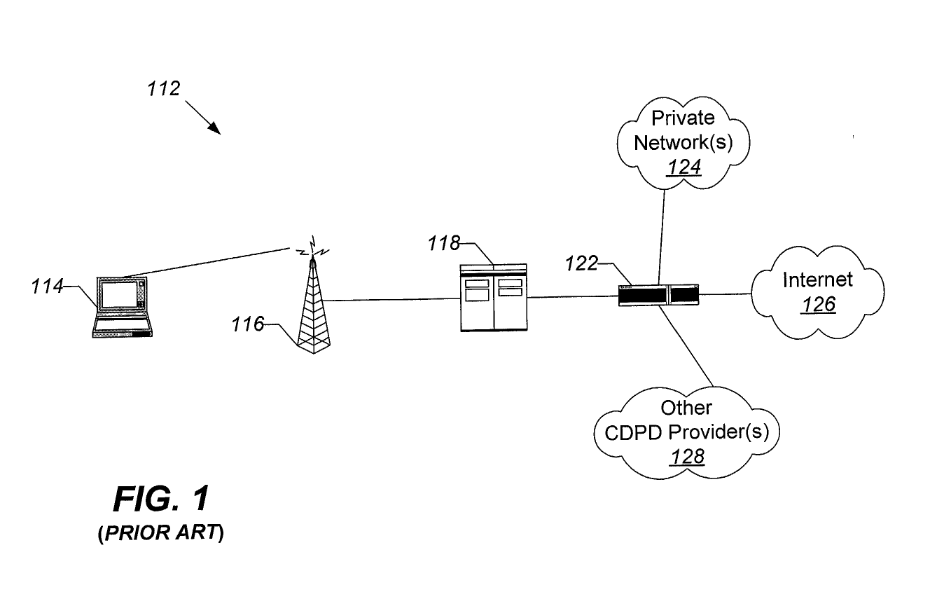

### DETAILED DESCRIPTION OF PREFERRED EMBODIMENTS

While the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention as defined by the claims. Like reference numbers signify like elements throughout the description of the figures.

For purposes of illustration, the present invention is described herein in the context of processing a packet in a cellular digital packet data (CDPD) communication network. It will be understood that the term “packet” means a unit of information that may be transmitted electronically as a whole from one device to another. Accordingly, as used herein, the term “packet” may encompass such terms of art as “frame” or “message,” which may also be used to refer to a unit of transmission. It will be further understood that the concepts and principles of the present invention are not limited to CDPD communication networks, but are generally applicable to communication networks in which a mobile terminal may receive data packets from multiple transmitters whose respective locations are known.

The present invention may be embodied as systems, methods, and/or computer program products. Accordingly, the present invention may be embodied in hardware and/or in software (including firmware, resident software, micro-code, etc.). Furthermore, the present invention may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific examples (a nonexhaustive list) of the computer-readable medium would include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

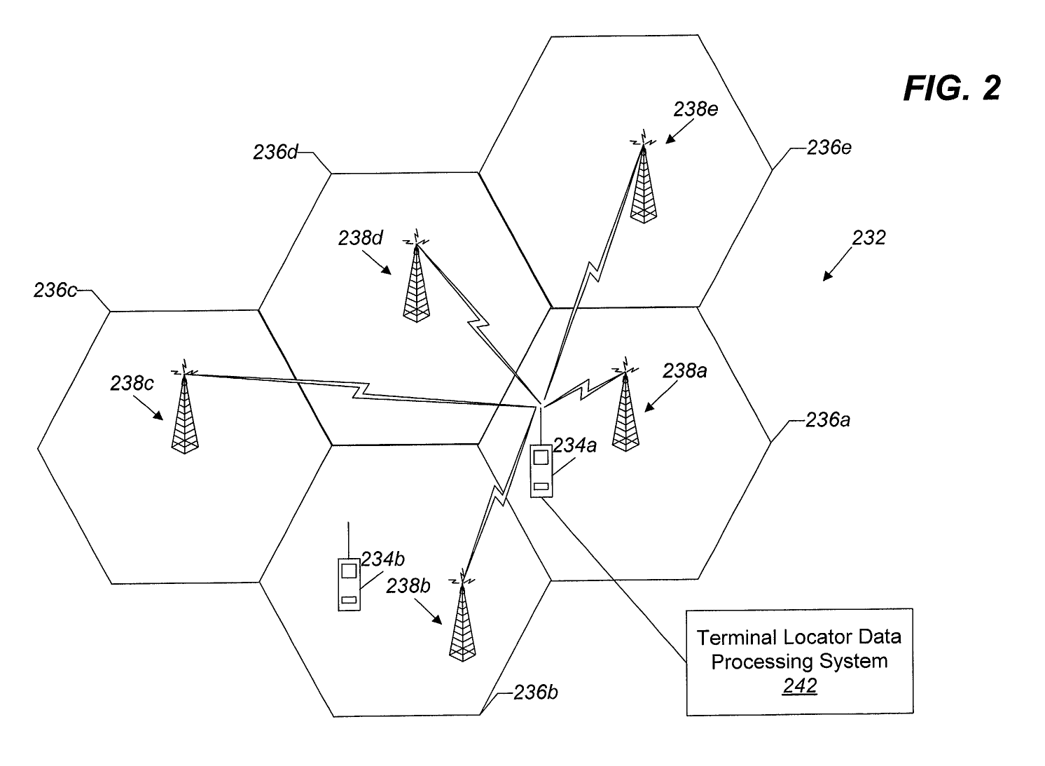

Referring now to FIG. 2, an exemplary CDPD communication network 232, in accordance with embodiments of the present invention, comprises one or more CDPD mobile end stations (M-ESs) that may be embodied as mobile terminals 234a,b. As used herein, the term “mobile terminal” may include a cellular radiotelephone with or without a multi-line display; a Personal Communications System (PCS) terminal that may combine a cellular radiotelephone with data processing, facsimile and data communications capabilities; a personal digital assistant (PDA) that can include a radiotelephone, pager, Internet/intranet access, Web browser, organizer, calendar and/or a GPS receiver; and a conventional laptop and/or palmtop receiver or other appliance that includes a radiotelephone transceiver. Mobile terminals may also be referred to as “pervasive computing” devices.

The mobile terminals 234a,b communicate via a plurality of cells 236a,b,c,d,e served by mobile data base stations (MDBSs) 238a,b,c,d,e. A function of the MDBSs 238a,b,c,d,e is to handle radio communication with the mobile terminals 234a,b. In this capacity, the MDBSs 238a,b,c,d,e may function as a relay station for data and voice signals. Although only five cells 236a,b,c,d,e are shown, a typical CDPD network may include hundreds of cells, and may serve thousands of mobile terminals 234a,b.

In addition, one or more MDBSs and/or mobile terminals may optionally communicate with a terminal locator data processing system 242 as shown with respect to MDBS 238a and mobile terminal 234a. This communication connection between the MDBS 238a and the mobile terminal 234a may be, for example, but not limited to, a wireless connection, a wireline connection, and/or an input/output bus interface that may facilitate the exchange of information between devices.

Although FIG. 2 illustrates an exemplary CDPD communication network 232 architecture, it will be understood that the present invention is not limited to such a configuration, but is intended to encompass any configuration capable of carrying out the operations described herein.

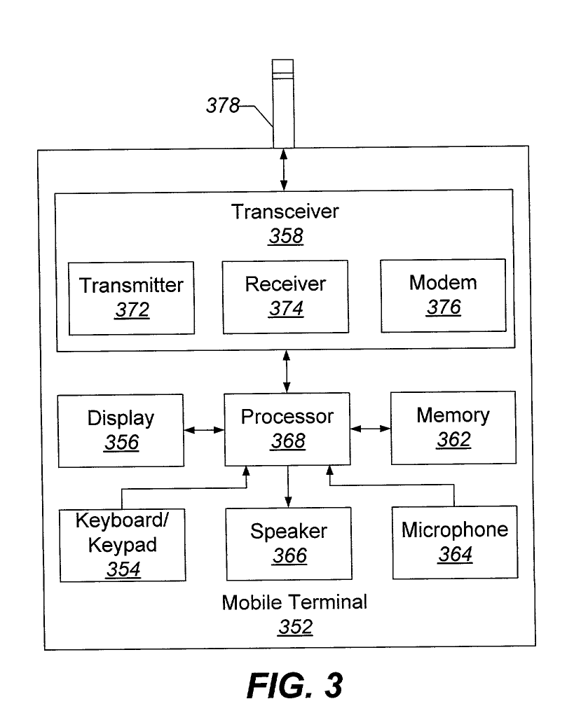

FIG. 3 illustrates a mobile terminal 352 that may be used in embodiments of the mobile terminals 234a,b of FIG. 2, in accordance with the present invention. The mobile terminal 352, in accordance with embodiments of the present invention, comprises a keyboard/keypad 354, a display 356, a transceiver 358, a memory 362, a microphone 364, and a speaker 366 that communicate with a processor 368. The transceiver 358 typically comprises a transmitter circuit 372, a receiver circuit 374, and a modem 376, which cooperate to transmit and receive radio frequency signals to MDBSs via an antenna 378. The radio frequency signals transmitted between the mobile terminal 352 and the MDBSs may comprise both traffic and control signals (e.g., paging signals/messages for incoming calls), which are used to establish and maintain communication with another party or destination. The radio frequency signals may also comprise CDPD packet data.

The foregoing components of the mobile terminal 352 may be included in many conventional CDPD mobile terminals/end stations and their functionality is generally known to those skilled in the art.

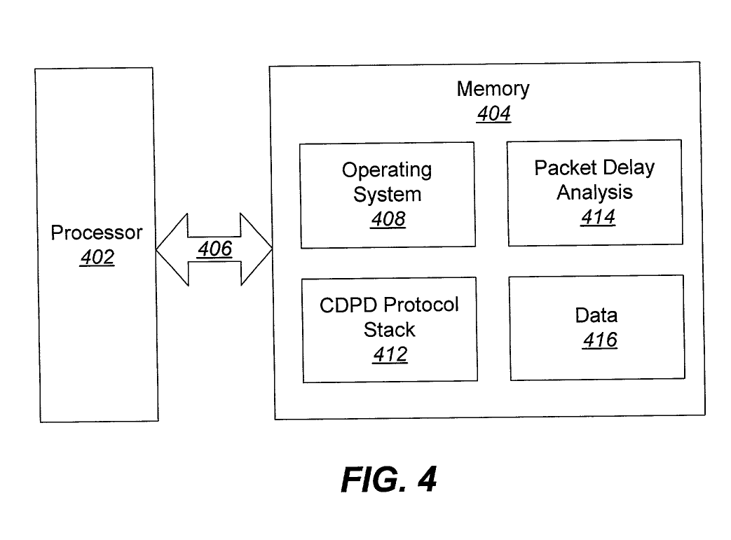

FIG. 4 illustrates a processor 402 and a memory 404 that may be used in embodiments of the mobile terminal 352 of FIG. 3 in accordance with the present invention. The processor 402 communicates with the memory 404 via an address/data bus 406. The processor 402 may be, for example, a commercially available or custom microprocessor. The memory 404 is representative of the overall hierarchy of memory devices containing the software and data used to determine the location of a mobile terminal based on delays in receiving data packets in accordance with embodiments of the present invention. The memory 404 may include, but is not limited to, the following types of devices: cache, ROM, PROM, EPROM, EEPROM, flash, SRAM, and DRAM.

As shown in FIG. 4, the memory 404 may have stored thereon an operating system 408, a CDPD protocol stack program module 412, a packet delay analysis program module 414, and a data module 416. The operating system 408 generally controls the operation of the mobile terminal's software and/or hardware resources and may coordinate execution of programs by the processor 402. The CDPD protocol stack module 412 may be configured to facilitate communication with MDBSs using the CDPD protocol. The packet delay analysis module 414 may be configured to determine delays in packets received from multiple MDBSs. These delay determinations may be stored in the data module 416.

Optionally, the data module 416 may be further configured to store the locations of MDBSs from which data packets may be received. For example, the MDBSs may transmit location coordinates to the mobile terminal for storage thereat using, for example, the CDPD protocol. In accordance with some embodiments of the present invention, the packet delay analysis module 414 may use algorithms, which will be described in detail hereinafter, to determine distances between the mobile terminal and the MDBSs from which packets are received based on the determined delays. Other algorithms may then be used to determine a location of the mobile terminal based on the determined distances and the known locations of the MDBSs.

Although FIG. 4 illustrates an exemplary mobile terminal software architecture that may facilitate determining the location of a mobile terminal based on delays in receiving data packets in accordance with embodiments of the present invention, it will be understood that the present invention is not limited to such a configuration but is intended to encompass any configuration capable of carrying out operations described herein.

Computer program code for carrying out operations of the respective mobile terminal program modules may be written in a high-level programming language, such as C or C++, for development convenience. In addition, computer program code for carrying out operations of the present invention may also be written in other programming languages, such as, but not limited to, interpreted languages. Some modules or routines may be written in assembly language or even micro-code to enhance performance and/or memory usage. It will be further appreciated that the functionality of any or all of the program modules may also be implemented using discrete hardware components, one or more application specific integrated circuits (ASICs), or a programmed digital signal processor or microcontroller.

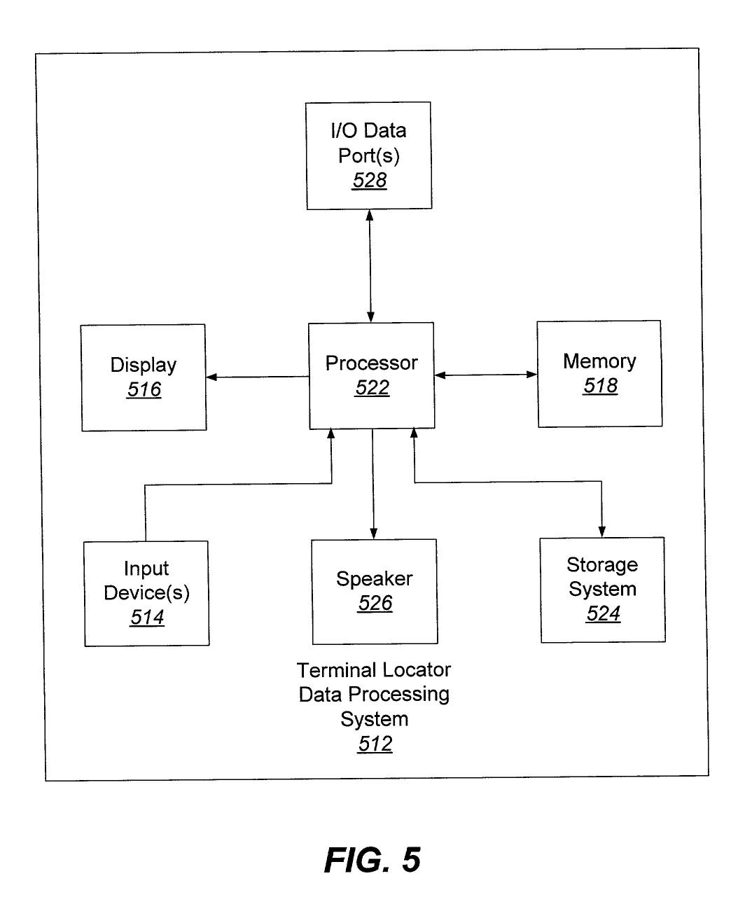

FIG. 5 illustrates a terminal locator data processing system 512 that may be used in embodiments of the terminal locator data processing system 242 of FIG. 2, in accordance with the present invention. The terminal locator data processing system 512, in accordance with embodiments of the present invention, comprises input device(s) 514, such as a keyboard or keypad, a display 516, and a memory 518 that communicate with a processor 522. The terminal locator data processing system 512 may further include a storage system 524, a speaker 526, and an input/output (I/O) data port(s) 528 that also communicate with the processor 522. The storage system 524 may include removable and/or fixed media, such as floppy disks, ZIP drives, hard disks, or the like, as well as virtual storage, such as a RAMDISK. The I/O data port(s) 528 may be used to transfer information between the terminal locator data processing system 512 and another computer system or a network (e.g., the Internet) using, for example, but not limited to, wireless, wireline, and/or communication bus technology. These terminal locator data processing system 512 components may be conventional components, such as those used in many conventional computing devices and/or systems, which may be configured to operate as described herein.

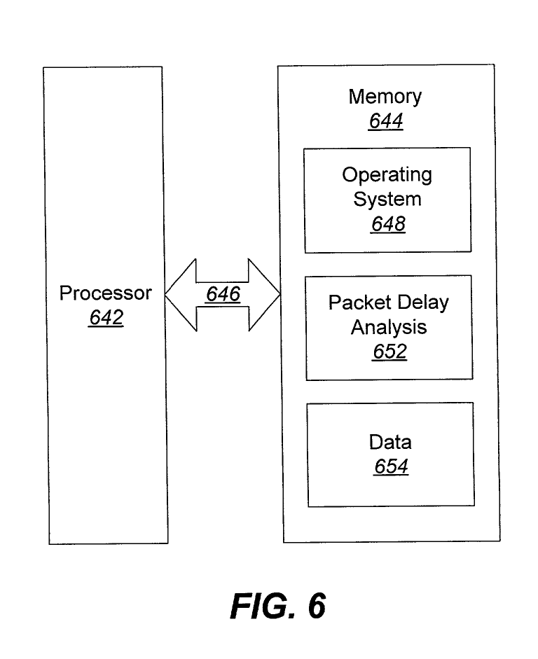

FIG. 6 illustrates a processor 642 and a memory 644 that may be used in embodiments of the terminal locator data processing system 512 of FIG. 5 in accordance with the present invention. The processor 642 communicates with the memory 644 via an address/data bus 646. The processor 642 may be, for example, a commercially available or custom microprocessor. The memory 644 is representative of the overall hierarchy of memory devices containing the software and data used to determine the location of a mobile terminal based on delays in receiving data packets in accordance with embodiments of the present invention. The memory 644 may include, but is not limited to, the following types of devices: cache, ROM, PROM, EPROM, EEPROM, flash, SRAM, and DRAM.

As shown in FIG. 6, the memory 644 may have stored thereon an operating system 648, a packet delay analysis program module 652, and a data module 654. The operating system 648 generally controls the operation of the computer system. In particular, the operating system 648 may manage the computer system's resources and may coordinate execution of programs by the processor 642. The packet delay analysis module 652 may be configured to receive data packet delay determinations from a mobile terminal directly and/or indirectly through, for example, one or more MDBSs. These data packet delays may be determined based on CDPD data packets received by the mobile terminal from multiple MDBSs as discussed above. Once the mobile terminal data packet delay determinations are received at the data processing system, they may be stored in the data module 654.

The data module 654 may be further configured to store the locations of MDBSs from which data packets may be received. For example, the MDBSs may transmit location coordinates to the terminal locator data processing system for storage thereat using, for example, the CDPD protocol. Like the packet delay analysis module 414 discussed above with reference to FIG. 4, the packet delay analysis module 652 may use algorithms, which will be described in detail hereinafter, to determine distances between the mobile terminal and the MDBSs from which packets are received based on the determined delays. Other algorithms may then be used to determine a location of the mobile terminal based on the determined distances and the known locations of the MDBSs.

Although FIG. 6 illustrates an exemplary data processing system software architecture that may facilitate determining the location of a mobile terminal based on delays in receiving data packets in accordance with embodiments of the present invention, it will be understood that the present invention is not limited to such a configuration but is intended to encompass any configuration capable of carrying out operations described herein.

Computer program code for carrying out operations of the respective data processing system program modules may be written in a high-level programming language, such as C or C++, for development convenience. In addition, computer program code for carrying out operations of the present invention may also be written in other programming languages, such as, but not limited to, interpreted languages. Some modules or routines may be written in assembly language or even micro-code to enhance performance and/or memory usage. It will be further appreciated that the functionality of any or all of the program modules may also be implemented using discrete hardware components, one or more application specific integrated circuits (ASICs), or a programmed digital signal processor or microcontroller.

The present invention is described hereinafter with reference to flowchart and/or block diagram illustrations of methods, systems, and computer program products in accordance with exemplary embodiments of the invention. It will be understood that each block of the flowchart and/or block diagram illustrations, and combinations of blocks in the flowchart and/or block diagram illustrations, may be implemented by computer program instructions and/or hardware operations. These computer program instructions may be provided to a processor of a general purpose computer, a special purpose computer, or other programmable data processing apparatus to produce a machine, such that the instructions, which execute via the processor of the computer or other programmable data processing apparatus, create means for implementing the functions specified in the flowchart and/or block diagram block or blocks.

These computer program instructions may also be stored in a computer usable or computer-readable memory that may direct a computer or other programmable data processing apparatus to function in a particular manner, such that the instructions stored in the computer usable or computer-readable memory produce an article of manufacture including instructions that implement the function specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart and/or block diagram block or blocks.

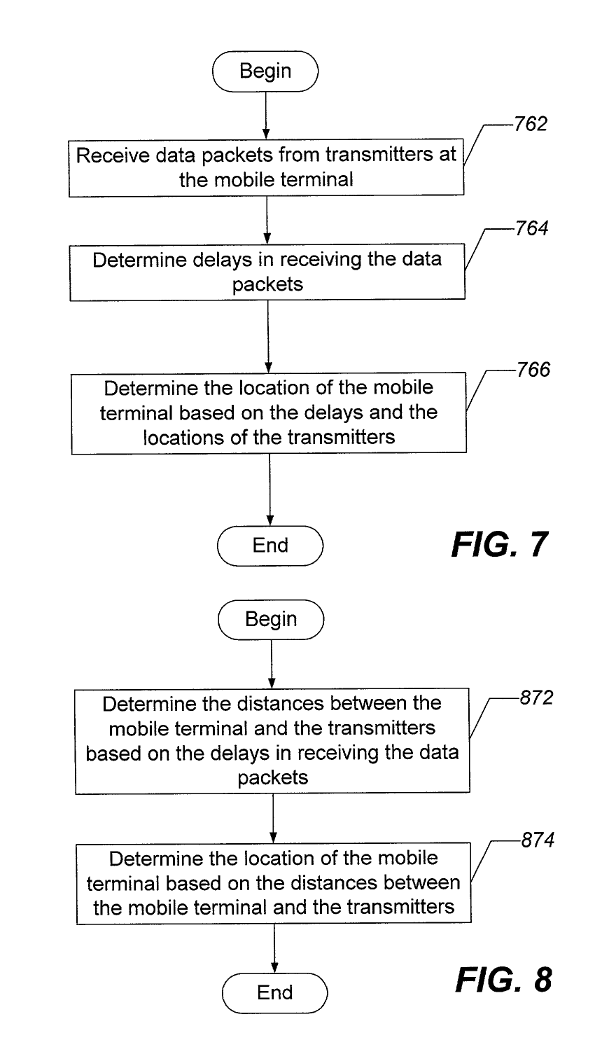

Referring now to FIG. 7, operations begin at block 762 where a mobile terminal receives data packets (e.g., CDPD data packets) from multiple transmitters, such as MDBSs. At block 764, the packet delay analysis module 414 (see FIG. 4) determines delays in receiving the data packets from the transmitters. The packet delay analysis module 414 then determines the location of the mobile terminal at block 766 based on the determined delays and the locations of the transmitters, which may be stored in the data module 416.

In more detail, the total delay in receiving a data packet at the mobile terminal corresponds to the total time to transmit the data packet at the transmitter and to receive the data packet at the mobile terminal. This total time may be given by Equation 1 below:

$${T}_{Total} = \frac{{S}_{Data}}{{D}_{Rate}} + {T}_{Pr ocess} + {T}_{Dist} \qquad EQ . 1$$

where S_{Data} is the size of the data packet; D_{Rate} is the data transmission rate used by the transmitter; T_{Process} is the total time taken by both the transmitter and the mobile terminal in processing the data packet after obtaining a start time for the transmission and prior to obtaining an end time signifying receipt of the data packet at the mobile terminal; and T_{Dist} is the time taken for the data packet to traverse the distance between the transmitter and the mobile terminal.

To determine T_{Total}, the transmitter may include a time stamp in the data packet that identifies a start time for the transmission. The mobile terminal may then obtain a system clock reading once receipt of the data packet is complete with T_{Total} being given by the difference between the local system clock reading at the mobile terminal and the time stamp in the data packet. The system clocks of the transmitter and the mobile terminal are preferably kept in synchronization to improve the accuracy of the T_{Total} determination. In other embodiments, the transmitter may start transmission of the data packet at a predefined time known by the mobile terminal, which may obviate the need to include a time stamp in the data packet.

To determine T_{Process}, the transmitter may include the time to process the data packet in a field in the data packet. The mobile terminal may track its own time to process the data packet using its own system clock. Alternatively, this processing time information may be a constant value or may be determined based on the size of the data packet.

The size of the data packet S_{Data} may be determined from the data packet and the data transmission rate D_{Rate} is known based on the communication protocol used. In CDPD networks, the transmission data rate is 19,200 bits/second.

In view of the foregoing, the packet delay analysis module 414 may determine a value for T_{Dist}. Referring now to FIG. 8, in accordance with embodiments of the present invention, the packet delay analysis module 414 determines the distances between the mobile terminal and the transmitters based on the delays in receiving the data packets at block 872. Specifically, the relationship between T_{Dist}, the time taken for the data packet to traverse the distance between the transmitter and the mobile terminal, and the distance between the transmitter and the mobile terminal is given by Equation 2 below:

$${T}_{Dist} = \frac{X}{C} \qquad EQ . 2$$

where X is the distance between the transmitter and the mobile terminal and C is the signal propagation speed associated with the communication medium over which the data packet is transmitted from the transmitter to the mobile terminal. Combining Equation 2 and Equation 1, the distance X may be given by Equation 3 below:

$$X = C ( {T}_{Total} - \frac{{S}_{Data}}{{D}_{Rate}} - {T}_{Pr ocess} ) \qquad EQ . 3$$

The packet delay analysis module 414 may then determine the location of the mobile terminal at block 874 based on the determined distances and the known locations of the multiple transmitters, which may be stored in the data module 416, as discussed above with reference to FIG. 4.

In accordance with preferred embodiments of the present invention, the mobile terminal determines delays in receiving data packets from at least three transmitters having different locations. For example, referring now to FIG. 2, the mobile terminal 234a may scan CDPD channels transmitted from MDBSs in its own cell and cells adjacent thereto, e.g., MDBSs 238a,b,d in cells 236a,b,d, respectively, to determine data packet delays. Alternatively, to determine as many data packet delays as possible for improved location accuracy, the mobile terminal 234a may scan channels from more than three transmitters, including CDPD channels transmitted from MDBSs that are located in cells that are not adjacent to cell 236a, such as MDBS 238c in cell 236c.

In other embodiments of the present invention, the location of the mobile terminal need not be determined by the mobile terminal. Instead, the packet delay analysis module 414 of the mobile terminal may transmit the information relevant to determining the data packet delays discussed above with reference to Equations 1-3 to a data processing system, such as the terminal locator data processing system 242 of FIG. 2. Using the information received from the mobile terminal, the packet delay analysis module 652 (see FIG. 6) determines delays in receiving the data packets from the transmitters as discussed above with reference to block 764 of FIG. 7. The packet delay analysis module 652 determines the distances between the mobile terminal and the transmitters based on the delays in receiving the data packets as discussed above with reference to block 872 of FIG. 8. The packet delay analysis module 652 may then determine the location of the mobile terminal based on the determined distances and the known locations of the multiple transmitters as discussed above with reference to FIG. 6. Once the location is determined, it may be communicated back to the mobile terminal.

Advantageously, the present invention may allow the location of a mobile terminal to be determined with greater accuracy than just an identification of a particular cell location. The accuracy achieved is related, however, to the accuracy of the signal strength measurements.

Because it may be difficult to synchronize the system clocks of the mobile terminal and the transmitters, it may be desirable to determine the location of a mobile terminal based on the round trip delay of packets sent between the mobile terminal and multiple transmitters.

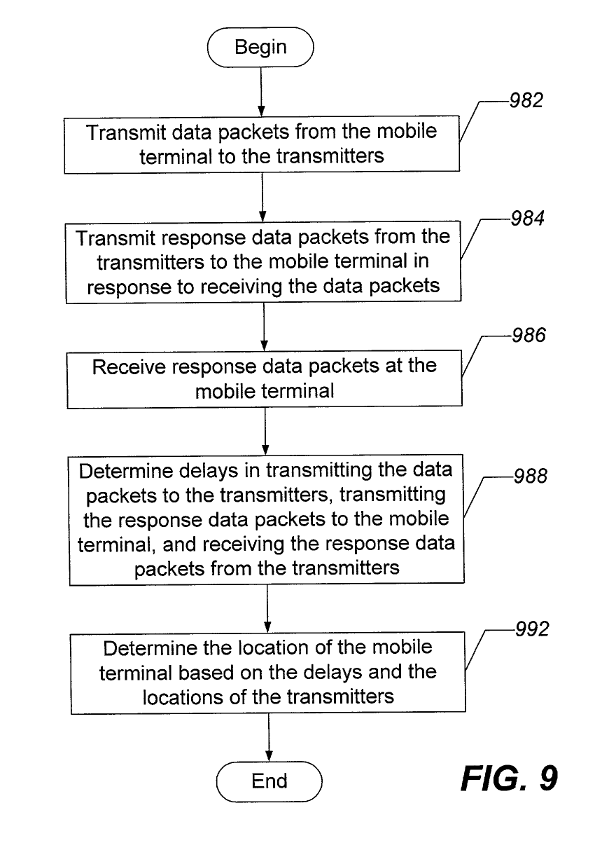

Referring now to FIG. 9, operations begin at block 982 where a mobile terminal transmits data packets (e.g., CDPD data packets) to multiple transmitters, such as MDBSs. At block 984, the transmitters transmit response data packets back to the mobile terminal responsive to receiving the data packets. The response data packets are received at the mobile terminal at block 986. At block 988, the packet delay analysis module 414 (see FIG. 4) determines delays in transmitting the data packets to the transmitters, transmitting the response data packets to the mobile terminal responsive to receiving the data packets at the transmitters, and receiving the response data packets from the transmitters at the mobile terminal. The packet delay analysis module 414 then determines the location of the mobile terminal at block 992 based on the determined delays and the locations of the transmitters, which may be stored in the data module 416.

In more detail, the total round trip delay in transmitting a packet from a mobile terminal to a transmitter and receiving a response data packet back from the transmitter corresponds to the total time to transmit the data packet to the transmitter, transmit the response data packet to the mobile terminal responsive to receiving the data packet at the transmitter, and receive the response data packet from the transmitter at the mobile terminal. This total time may be given by Equation 4 below:

$${T}_{Total2} = \frac{{S}_{Data}}{{D}_{Rate}} + \frac{{S}_{Re sp}}{{D}_{Rate}} + {T}_{Pr ocess2} + 2 {T}_{Dist} \qquad EQ . 4$$

where S_{Resp} is the size of the response data packet; D_{Rate} is the data transmission rate used by both the mobile terminal and the transmitter; and T_{Process2} is the total time taken by both the transmitter and the mobile terminal in processing the data packet and the response data packet after obtaining a start time for transmission of the data packet from the mobile terminal and prior to obtaining an end time signifying receipt of the response data packet at the mobile terminal.

To determine T_{Total2}, the mobile terminal may obtain a system clock reading upon initiating the process for transmitting the data packet to the transmitter and may obtain a second system clock reading once receipt of the response data packet is complete with T_{Total2}, being given by the difference between the two system clock readings. Advantageously, the determination of T_{Total2}, is not dependent upon the mobile terminal system clock and the transmitter system clock being in synchronization with one another, which may result in improved precision in the ultimate location determination of the mobile terminal. T_{Process2}, may be determined in the same manner as T_{Process} discussed above.

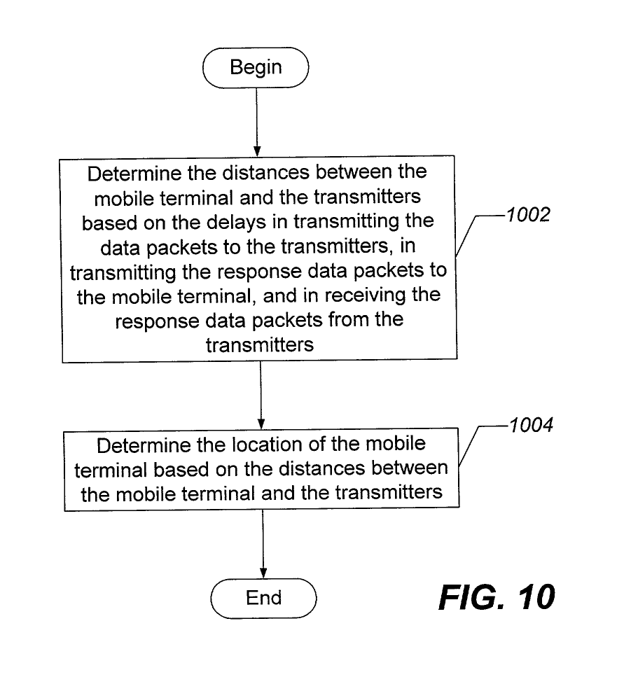

Referring now to FIG. 10, in accordance with embodiments of the present invention, the packet delay analysis module 414 determines the distances between the mobile terminal and the transmitters based on the delays in transmitting the data packets to the transmitters, transmitting the response data packets to the mobile terminal responsive to receiving the data packets at the transmitters, and receiving the response data packets from the transmitters at the mobile terminal at block 1002. Specifically, the relationship between T_{Dist}, the time taken for the data packet or the response data packet to traverse the distance between the transmitter and the mobile terminal, and the distance between the transmitter and the mobile terminal is given by Equation 2 above.

Combining Equation 2 and Equation 4, the distance X may be given by Equation 5 below:

$$X = \frac{C ( {T}_{Total2} - \frac{{S}_{Data}}{{D}_{Rate}} - \frac{{S}_{Re sp}}{{D}_{Rate}} {T}_{Pr ocess2} )}{2} \qquad EQ . 5$$

The packet delay analysis module 414 may then determine the location of the mobile terminal at block 1004 based on the determined distances and the known locations of the multiple transmitters, which may be stored in the data module 416, as discussed above with reference to FIG. 4.

In other embodiments of the present invention, the location of the mobile terminal based on the round trip delay of packets sent between the mobile terminal and multiple transmitters need not be determined by the mobile terminal, but instead may be determined at a terminal locator data processing system 242 as discussed above.

The flowcharts of FIGS. 7-10 illustrate the architecture, functionality, and operations of embodiments of the mobile terminal 352 and the terminal locator data processing system 512 software. In this regard, each block represents a module, segment, or portion of code, which comprises one or more executable instructions for implementing the specified logical function(s). It should also be noted that in some alternative implementations, the function(s) noted in the blocks may occur out of the order noted in FIGS. 7-10. For example, two blocks shown in succession may, in fact, be executed substantially concurrently or the blocks may sometimes be executed in the reverse order, depending on the functionality involved.

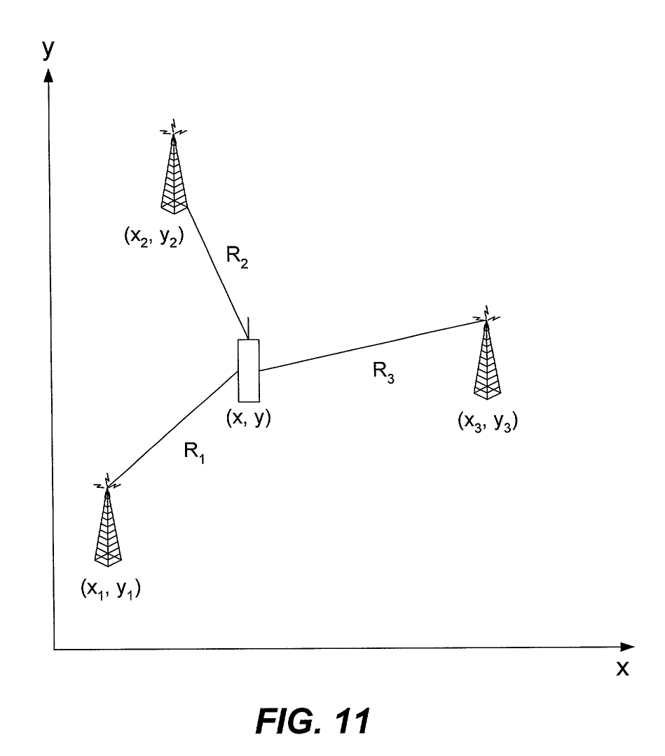

An exemplary methodology for determining a location of a mobile terminal, in accordance with embodiments of the present invention, will now be described with reference to FIG. 11. A mobile terminal at position (x, y) is located a distance R₁ from a first transmitter at position (x₁, y₁), a distance R₂ from a second transmitter at position (x₂, y₂), and a distance R₃ from a third transmitter at position (x₃, y₃). The relationship between the distances R₁, R₂, and R₃, is given by Equations 6 through 8 as follows:

R₁²=(x−x₁)²+(y−y₁)² EQ. 6

R₂²=(x−x₂)²+(y−y₂)² EQ. 7

R₃²=(x−x₃)²+(y−y₃)² EQ. 8

If R₁=500 m, x₁=100 m, y₁=100 m, R₂=300 m, x₂=400 m, y₂=800 m, R₃=600 m, x₃=1000 m, and y₃=500 m, then, using Equations 6 through 8, x=400 m and y=500 m.

Many variations and modifications can be made to the preferred embodiments without substantially departing from the principles of the present invention. All such variations and modifications are intended to be included herein within the scope of the present invention, as set forth in the following claims.

We claim:

1. A method of determining a location of a mobile terminal, comprising:
receiving, at the mobile terminal, respective data packets from respective ones of at least three transmitters whose respective locations are known, the respective locations of the at least three transmitters being different from each other;
determining respective delays for the respective data packets to travel from the respective ones of the at least three transmitters to the mobile terminal; and
determining the location of the mobile terminal based on the respective delays and the respective locations of the at least three transmitters.

2. The method of claim 1, wherein determining the respective delays for the respective data packets to travel from the respective ones of the at least three transmitters to the mobile terminal comprises determining respective distances between the mobile terminal and the respective ones of the at least three transmitters based on the respective delays; and
wherein determining the location of the mobile terminal based on the respective delays and the respective locations of the at least three transmitters comprises determining the location of the mobile terminal based on the respective distances between the mobile terminal and the respective ones of the at least three transmitters.

3. The method of claim 2, wherein determining the respective distances between the mobile terminal and the respective ones of the at least three transmitters based on the respective delays comprises:
determining respective total times to transmit the respective data packets from the respective ones of at least three transmitters and to receive the respective data packets at the mobile terminal;
subtracting respective times to process the respective data packets in both the respective ones of the at least three transmitters and the mobile terminal from the respective total times to generate respective first results;
determining respective times for the respective ones of the at least three transmitters to transmit the respective data packets;
subtracting the respective times for the respective ones of the at least three transmitters to transmit the respective data packets from the respective first results to generate respective second results; and
multiplying the respective second results by a signal propagation speed that is associated with a communication medium over which the respective data packets are transmitted from the respective ones of the at least three transmitters to the mobile terminal.

4. The method of claim 3, wherein determining the respective total times to transmit the respective data packets from the respective ones of at least three transmitters and to receive the respective data packets at the mobile terminal comprises determining the respective total times to transmit the respective data packets from the respective ones of at least three transmitters and to receive the respective data packets at the mobile terminal based on respective time stamp information in the respective data packets.

5. The method of claim 3, wherein determining the respective times for the respective ones of the at least three transmitters to transmit the respective data packets comprises:
determining respective sizes of the data packets; and
dividing the respective sizes of the data packets by respective data transmission rates associated with respective ones of the at least three transmitters.

6. The method of claim 1, wherein determining the location of the mobile terminal based on the respective delays and the respective locations of the at least three transmitters comprises:
transmitting the respective delays to a data processing system, the data processing system being programmed with the respective locations of the at least three transmitters; and
determining, at the data processing system, the location of the mobile terminal based on the respective delays and the respective locations of the at least three transmitters.

7. The method of claim 1, wherein determining the location of the mobile terminal based on the respective delays and the respective locations of the at least three transmitters comprises:
receiving, at the mobile terminal, the respective locations of the at least three transmitters from the at least three transmitters; and
determining, at the mobile terminal, the location of the mobile terminal based on the respective delays and the respective locations of the at least three transmitters.

8. The method of claim 1, wherein the respective ones of the at least three transmitters comprise respective ones of a plurality of mobile data base stations, and wherein the received signals are cellular digital packet data (CDPD) signals.

9. The method of claim 8, wherein respective ones of the at least three transmitters are associated with respective ones of at least three cells, wherein the mobile terminal is located in one of the at least three cells, and wherein the one of the at least three cells is adjacent to other ones of the at least three cells.

10. The method of claim 8, wherein respective ones of the at least three transmitters are associated with respective ones of at least three cells, wherein the mobile terminal is located in one of the at least three cells, and wherein receiving, at the mobile terminal, the respective data packets from the respective ones of the at least three transmitters whose respective locations are known comprises:
scanning respective CDPD channels that are associated with respective other ones of the at least three cells, which are adjacent to the one of the at least three cells.

11. The method of claim 8, wherein respective ones of the at least three transmitters are associated with respective ones of at least three cells, wherein the mobile terminal is located in one of the at least three cells, and wherein other ones of the at least three cells comprise at least one cell that is adjacent to the one of the at least three cells and at least one cell that is not adjacent to the one of the at least three cells.

12. The method of claim 8, wherein respective ones of the at least three transmitters are associated with respective ones of at least three cells, wherein the mobile terminal is located in one of the at least three cells, and wherein receiving, at the mobile terminal, the respective data packets from the respective ones of the at least three transmitters whose respective locations are known comprises:
scanning respective CDPD channels that are associated with respective other ones of the at least three cells, which comprise at least one cell that is adjacent to the one of the at least three cells and at least one cell that is not adjacent to the one of the at least three cells.

13. A method of determining a location of a mobile terminal, comprising:
transmitting, from the mobile terminal, respective data packets to respective ones of the at least three transmitters whose respective locations are known, the respective locations of the at least three transmitters being different from each other;
transmitting, from the respective ones of the at least three transmitters, respective response data packets to the mobile terminal responsive to receiving the respective data packets at the respective ones of the at least three transmitters;
receiving, at the mobile terminal, respective response data packets from the respective ones of the at least three transmitters;
determining respective delays for the respective data packets to travel from the mobile terminal to the respective ones of the at least three transmitters and for the respective response data packets to travel from the respective ones of the at least three transmitters to the mobile terminal; and
determining the location of the mobile terminal based on the respective delays and the respective locations of the at least three transmitters.

14. The method of claim 13, wherein determining the respective delays for the respective data packets to travel from the mobile terminal to the respective ones of the at least three transmitters and for the respective response data packets to travel from the respective ones of the at least three transmitters to the mobile terminal comprises determining respective distances between the mobile terminal and the respective ones of the at least three transmitters based on the respective delays; and
wherein determining the location of the mobile terminal based on the respective delays and the respective locations of the at least three transmitters comprises determining the location of the mobile terminal based on the respective distances between the mobile terminal and the respective ones of the at least three transmitters.

15. The method of claim 14, wherein determining the respective distances between the mobile terminal and the respective ones of the at least three transmitters based on the respective delays comprises:
determining respective total times to transmit the respective data packets to the respective ones of the at least three transmitters, to receive the respective data packets at the respective ones of the at least three transmitters, to transmit the respective response data packets to the mobile terminal, and to receive the respective response data packets from the respective ones of the at least three transmitters;
subtracting respective times to process the respective data packets in both the respective ones of the at least three transmitters and the mobile terminal from the respective total times to generate respective first results;
subtracting respective times to process the respective response data packets in both the respective ones of the at least three transmitters and the mobile terminal from the respective first results to generate respective second results;
determining respective times for the mobile terminal to transmit the respective data packets;
subtracting the respective times for the mobile terminal to transmit the respective data packets from the respective second results to generate respective third results;
determining respective times for the respective ones of the at least three transmitters to transmit the respective response data packets;
subtracting the respective times for the respective ones of the at least three transmitters to transmit the respective response data packets from the respective third results to generate respective fourth results; and
multiplying the respective fourth results by a signal propagation speed that is associated with a communication medium over which the respective data packets are transmitted from the mobile terminal to the respective ones of the at least three transmitters, and over which the respective response data packets are transmitted from the respective ones of the at least three transmitters to the mobile terminal.

16. A system for determining a location of a mobile terminal, comprising:
means for receiving, at the mobile terminal, respective data packets from respective ones of at least three transmitters whose respective locations are known, the respective locations of the at least three transmitters being different from each other;
means for determining respective delays for the respective data packets to travel from the respective ones of the at least three transmitters to the mobile terminal; and
means for determining the location of the mobile terminal based on the respective delays and the respective locations of the at least three transmitters.

17. The system of claim 16, wherein the means for determining the respective delays for the respective data packets to travel from the respective ones of the at least three transmitters to the mobile terminal comprises means for determining respective distances between the mobile terminal and the respective ones of the at least three transmitters based on the respective delays; and
wherein the means for determining the location of the mobile terminal based on the respective delays and the respective locations of the at least three transmitters comprises means for determining the location of the mobile terminal based on the respective distances between the mobile terminal and the respective ones of the at least three transmitters.

18. The system of claim 17, wherein the means for determining the respective distances between the mobile terminal and the respective ones of the at least three transmitters based on the respective delays comprises:
means for determining respective total times to transmit the respective data packets from the respective ones of at least three transmitters and to receive the respective data packets at the mobile terminal;
means for subtracting respective times to process the respective data packets in both the respective ones of the at least three transmitters and the mobile terminal from the respective total times to generate respective first results;
means for determining respective times for the respective ones of the at least three transmitters to transmit the respective data packets;
means for subtracting the respective times for the respective ones of the at least three transmitters to transmit the respective data packets from the respective first results to generate respective second results; and
means for multiplying the respective second results by a signal propagation speed that is associated with a communication medium over which the respective data packets are transmitted from the respective ones of the at least three transmitters to the mobile terminal.

19. The system of claim 18, wherein the means for determining the respective total times to transmit the respective data packets from the respective ones of at least three transmitters and to receive the respective data packets at the mobile terminal comprises means for determining the respective total times to transmit the respective data packets from the respective ones of at least three transmitters and to receive the respective data packets at the mobile terminal based on respective time stamp information in the respective data packets.

20. The system of claim 18, wherein the means for determining the respective times for the respective ones of the at least three transmitters to transmit the respective data packets comprises:
means for determining respective sizes of the data packets; and
means for dividing the respective sizes of the data packets by respective data transmission rates associated with respective ones of the at least three transmitters.

21. A system for determining a location of a mobile terminal, comprising:
means for transmitting, from the mobile terminal, respective data packets to respective ones of the at least three transmitters whose respective locations are known, the respective locations of the at least three transmitters being different from each other;
means for transmitting, from the respective ones of the at least three transmitters, respective response data packets to the mobile terminal responsive to receiving the respective data packets at the respective ones of the at least three transmitters;
means for receiving, at the mobile terminal, respective response data packets from the respective ones of the at least three transmitters;
means for determining respective delays for the respective data packets to travel from the mobile terminal to the respective ones of the at least three transmitters and for the respective response data packets to travel from the respective ones of the at least three transmitters to the mobile terminal; and
means for determining the location of the mobile terminal based on the respective delays and the respective locations of the at least three transmitters.

22. The system of claim 21, wherein the means for determining the respective delays for the respective data packets to travel from the mobile terminal to the respective ones of the at least three transmitters and for the respective response data packets to travel from the respective ones of the at least three transmitters to the mobile terminal comprises means for determining respective distances between the mobile terminal and the respective ones of the at least three transmitters based on the respective delays; and
wherein the means for determining the location of the mobile terminal based on the respective delays and the respective locations of the at least three transmitters comprises means for determining the location of the mobile terminal based on the respective distances between the mobile terminal and the respective ones of the at least three transmitters.

23. The system of claim 22, wherein the means for determining the respective distances between the mobile terminal and the respective ones of the at least three transmitters based on the respective delays comprises:
means for determining respective total times to transmit the respective data packets to the respective ones of the at least three transmitters, to receive the respective data packets at the respective ones of the at least three transmitters, to transmit the respective response data packets to the mobile terminal, and to receive the respective response data packets from the respective ones of the at least three transmitters;
means for subtracting respective times to process the respective data packets in both the respective ones of the at least three transmitters and the mobile terminal from the respective total times to generate respective first results;
means for subtracting respective times to process the respective response data packets in both the respective ones of the at least three transmitters and the mobile terminal from the respective first results to generate respective second results;
means for determining respective times for the mobile terminal to transmit the respective data packets;
means for subtracting the respective times for the mobile terminal to transmit the respective data packets from the respective second results to generate respective third results;
means for determining respective times for the respective ones of the at least three transmitters to transmit the respective response data packets;
means for subtracting the respective times for the respective ones of the at least three transmitters to transmit the respective response data packets from the respective third results to generate respective fourth results; and
means for multiplying the respective fourth results by a signal propagation speed that is associated with a communication medium over which the respective data packets are transmitted from the mobile terminal to the respective ones of the at least three transmitters, and over which the respective response data packets are transmitted from the respective ones of the at least three transmitters to the mobile terminal.

24. A computer program product for determining a location of a mobile terminal, comprising:
a computer readable storage medium having computer readable program code embodied therein, the computer readable program code comprising:
computer readable program code for receiving, at the mobile terminal, respective data packets from respective ones of at least three transmitters whose respective locations are known, the respective locations of the at least three transmitters being different from each other;
computer readable program code for determining respective delays for the respective data packets to travel from the respective ones of the at least three transmitters to the mobile terminal; and
computer readable program code for determining the location of the mobile terminal based on the respective delays and the respective locations of the at least three transmitters.

25. The computer program product of claim 24, wherein the computer readable program code for determining the respective delays for the respective data packets to travel from the respective ones of the at least three transmitters to the mobile terminal comprises computer readable program code for determining respective distances between the mobile terminal and the respective ones of the at least three transmitters based on the respective delays; and
wherein the computer readable program code for determining the location of the mobile terminal based on the respective delays and the respective locations of the at least three transmitters comprises computer readable program code for determining the location of the mobile terminal based on the respective distances between the mobile terminal and the respective ones of the at least three transmitters.

26. The computer program product of claim 25, wherein the computer readable program code for determining the respective distances between the mobile terminal and the respective ones of the at least three transmitters based on the respective delays comprises:
computer readable program code for determining respective total times to transmit the respective data packets from the respective ones of at least three transmitters and to receive the respective data packets at the mobile terminal;
computer readable program code for subtracting respective times to process the respective data packets in both the respective ones of the at least three transmitters and the mobile terminal from the respective total times to generate respective first results;
computer readable program code for determining respective times for the respective ones of the at least three transmitters to transmit the respective data packets;
computer readable program code for subtracting the respective times for the respective ones of the at least three transmitters to transmit the respective data packets from the respective first results to generate respective second results; and
computer readable program code for multiplying the respective second results by a signal propagation speed that is associated with a communication medium over which the respective data packets are transmitted from the respective ones of the at least three transmitters to the mobile terminal.

27. The computer program product of claim 26, wherein the computer readable program code for determining the respective total times to transmit the respective data packets from the respective ones of at least three transmitters and to receive the respective data packets at the mobile terminal comprises computer readable program code for determining the respective total times to transmit the respective data packets from the respective ones of at least three transmitters and to receive the respective data packets at the mobile terminal based on respective time stamp information in the respective data packets.

28. The computer program product of claim 26, wherein the computer readable program code for determining the respective times for the respective ones of the at least three transmitters to transmit the respective data packets comprises:
computer readable program code for determining respective sizes of the data packets; and
computer readable program code for dividing the respective sizes of the data packets by respective data transmission rates associated with respective ones of the at least three transmitters.

29. A computer program product for determining a location of a mobile terminal, comprising:
a computer readable storage medium having computer readable program code embodied therein, the computer readable program code comprising:
computer readable program code for transmitting, from the mobile terminal, respective data packets to respective ones of the at least three transmitters whose respective locations are known, the respective locations of the at least three transmitters being different from each other;
computer readable program code for transmitting, from the respective ones of the at least three transmitters, respective response data packets to the mobile terminal responsive to receiving the respective data packets at the respective ones of the at least three transmitters;
computer readable program code for receiving, at the mobile terminal, respective response data packets from the respective ones of the at least three transmitters;
computer readable program code for determining respective delays for the respective data packets to travel from the mobile terminal to the respective ones of the at least three transmitters and for the respective response data packets to travel from the respective ones of the at least three transmitters to the mobile terminal; and
computer readable program code for determining the location of the mobile terminal based on the respective delays and the respective locations of the at least three transmitters.

30. The computer program product of claim 29, wherein the computer readable program code for determining the respective delays for the respective data packets to travel from the mobile terminal to the respective ones of the at least three transmitters and for the respective response data packets to travel from the respective ones of the at least three transmitters to the mobile terminal comprises computer readable program code for determining respective distances between the mobile terminal and the respective ones of the at least three transmitters based on the respective delays; and
wherein the computer readable program code for determining the location of the mobile terminal based on the respective delays and the respective locations of the at least three transmitters comprises computer readable program code for determining the location of the mobile terminal based on the respective distances between the mobile terminal and the respective ones of the at least three transmitters.

31. The computer program product of claim 30, wherein the computer readable program code for determining the respective distances between the mobile terminal and the respective ones of the at least three transmitters based on the respective delays comprises:
computer readable program code for determining respective total times to transmit the respective data packets to the respective ones of the at least three transmitters, to receive the respective data packets at the respective ones of the at least three transmitters, to transmit the respective response data packets to the mobile terminal, and to receive the respective response data packets from the respective ones of the at least three transmitters;
computer readable program code for subtracting respective times to process the respective data packets in both the respective ones of the at least three transmitters and the mobile terminal from the respective total times to generate respective first results;
computer readable program code for subtracting respective times to process the respective response data packets in both the respective ones of the at least three transmitters and the mobile terminal from the respective first results to generate respective second results;
computer readable program code for determining respective times for the mobile terminal to transmit the respective data packets;
computer readable program code for subtracting the respective times for the mobile terminal to transmit the respective data packets from the respective second results to generate respective third results;
computer readable program code for determining respective times for the respective ones of the at least three transmitters to transmit the respective response data packets;
computer readable program code for subtracting the respective times for the respective ones of the at least three transmitters to transmit the respective response data packets from the respective third results to generate respective fourth results; and
computer readable program code for multiplying the respective fourth results by a signal propagation speed that is associated with a communication medium over which the respective data packets are transmitted from the mobile terminal to the respective ones of the at least three transmitters, and over which the respective response data packets are transmitted from the respective ones of the at least three transmitters to the mobile terminal.
